(19) United States
(12) Patent Application Publication
(10) Pub. No.: US 2006/0091023 A1
(43) Pub. Date: May 4, 2006

(54) Assessing micro-via formation PCB substrate manufacturing process

(76) Inventors: Ahsan Bukhari, Tucson, AZ (US); Charan Gurumuthy, Higley, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/975,329

(22) Filed: Oct. 28, 2004

(51) Int. Cl. G01N 27/26; G01N 17/00

(52) U.S. Cl. 205/791.5; 204/402

(57) ABSTRACT

Embodiments of the invention include methods and systems of assessing micro-via formation in a substrate manufacturing process. In one embodiment of the invention, a microvia opening is drilled through a top dielectric layer of a multilayer printed circuit board (PCB) substrate, the multilayer PCB substrate including the microvia opening is desmeared down to a capture pad in a conductive layer; a sequential electrochemical reduction analysis is performed over the capture pad within the microvia opening to determine if there is any existing contamination in the bottom of the microvia opening. If a contaminant is found, production is put on hold and appropriate actions are taken to understand the source of contamination. Without any contamination, the microvias along with the remaining circuitry of the PCB substrate may be plated with a seed layer of Electroless plating followed by electrolytic plating.

### FIELD

Embodiments of the invention relate generally to printed circuit board (PCB) manufacturing, and specifically to assessing the micro-via formation process in the substrate of the printed circuit board (PCB).

### BACKGROUND

As manufacturing technology has rapidly changed to provide greater density in integrated circuits, the manufacturing of printed circuit boards (also referred to as printed wiring boards) has progressed more slowly in providing greater density. Multilayer printed circuit boards having more than one conductive interconnect layer made of a conductive material, such as copper for example, are common.

One technological development in the manufacture of printed circuit boards is a micro-via or microvia (sometimes denoted as uVia herein for short). A microvia is a hole or opening that connects an outer conductive layer of a printed circuit board to the nearest inner conductive layer. Due to the small diameter of both microvias and the pads to which they connect, designers are able to increase the circuit density of a printed circuit board. This can, in turn, lead to reduced size and cost of electronic products.

While microvias have led to greater circuit densities, it has increased the complexity in manufacturing a multilayer printed circuit board such that the reliability of a microvia has become very important. Traditional testing for the reliability of a microvia has been performed at the end of the line (“EOL”) in the manufacturing process. End of line testing may be too late to take corrective action to correct microvia defects. In which case, a printed circuit board at the end of the line with microvia defects may have to be scrapped.

Additionally, when substrates are stressed to higher thermal shocks, a weak microvia interface may start to crack and delaminate, creating an open failure. Root cause of the weak microvia interface is usually attributed to contamination at the bottom of the microvia due to resin residue or oxidation of a copper (cu) pad after a desmear process is performed.

Previously there had been very limited monitoring or monitors used that would detect this microvia contamination and contain any contamination problem in real time, prior to reaching the end of the line in the manufacturing process. That is, previously there were no inline monitors to detect the contamination of a microvia pad before electroless (“Eless”) plating. Current monitors for microvia reliability, namely “Via Pop” and “R-Shift”, are typically done at the end of the line (EOL) making it difficult to contain an excursion (e.g., a contamination problem) in real time. A “Via Pop” is a monitor whereby a microvia is formed, desmeared and plated and then peeled off. If the microvia loosely adhered to a capture pad due to any contamination (i.e., a poorly formed microvia), chances of its breakage are higher when compared to a good microvia that has good adhesion to the capture pad. An “R-shift” (resistance shift) is a monitor whereby the substrate is stressed at the end of the line (EOL). The resistance of the microvia is measured before and after the stressing of the substrate. If the resistance of the microvia shifts more than 10%, the microvia is considered to be at high risk for delamination and reliability failure when the die is attached. Typically it takes four to five weeks after the microvia processing is complete for the PCB substrate to reach the end of the line (EOL) in the manufacturing process for an assembled printed circuit board. Also, current inline monitors do not always detect potential microvia related issues. The monitors in current use at the end of the line can only detect defects at Defects Per Million (dpm) levels and are unable to catch or detect any gross contamination of a microvia.

Microvia reliability may be such a problem that a manufacturing line for printed circuit board substrates has to be shut down to determine the cause of failure. In addition, if marginal units are shipped to an end user and fail in the field, it would have significant impact to a company's quality standards.

### BRIEF DESCRIPTION OF THE DRAWINGS

FIG. 1A illustrates a top view of an exemplary multilayer printed circuit board with microvias.

FIG. 1B illustrates a cutaway view of an exemplary packaged integrated circuit including a multilayer printed circuit board substrate with microvias.

FIG. 2A illustrates a magnified top view of a microvia in a multilayer printed circuit board.

FIG. 2B illustrates a magnified cross-sectional view of a microvia in a multilayer printed circuit board.

FIG. 3 illustrates a functional block diagram of a method of microvia formation in accordance with embodiments of the invention.

FIGS. 4A-4F illustrate magnified cross-sectional views of a structural formation of a microvia.

FIG. 5 illustrates a chart including curves indicating measurements of copper oxidation for different periods of time after desmear using sequential electrochemical reduction analysis (SERA).

FIG. 6 illustrates a chart including a curve indicating a typical measurement using sequential electrochemical reduction analysis (SERA) to detect contamination.

FIG. 7 illustrates a chart including a pair of curves indicating measurements of a contaminated microvia and an uncontaminated microvia using sequential electrochemical reduction analysis (SERA).

FIG. 8 illustrates a block diagram of an exemplary sequential electrochemical reduction analysis (SERA) system used to detect contamination in a microvia.

### DETAILED DESCRIPTION

In the following detailed description of embodiments of the invention, numerous specific details are set forth to provide a thorough understanding of the invention. However, it will be obvious to one skilled in the art that the embodiments of the invention may be practiced without these specific details. In other instances well known methods, procedures, components, and circuits have not been described in detail so as not to unnecessarily obscure aspects of the embodiments of the invention.

Generally, embodiments of the invention use a sequential electrochemical reduction analysis (SERA) to monitor microvia reliability in a substrate manufacturing process for a multilayer printed circuit board. SERA is an electrochemical process typically used to determine a variety of coating parameters that can predict solderability of surface contacts and through-holes of printed circuit boards and wirebondability to a wire bond pad of an integrated circuit. Typically, a small, well defined area is isolated on a test piece and a current is applied to oxidize a surface species. Potential is recorded over time yielding a series of plateaus corresponding to the appearance of oxidation. The voltage levels identify the species present and the time at each level measures the amount present. From a graphic representation of the voltage levels over time, it may be determined that there is coating contamination, coating thickness problems, coating porosity, or composition problems. Traditionally, SERA metrology was considered to be a surface analysis tool that uses reduction-oxidation (Red-Ox) reactions to detect and quantify the surface conditions such as Oxides, sulfides, resin residues, etc. It is well established that SERA can be used for detecting organic contamination and copper (Cu) oxides (both copper-oxide CuO and dicopper-oxide Cu₂O). Now SERA can be used both as a destructive or a non-destructive technique of inline metrology of microvia reliability.

In one embodiment of the invention, a method is provided that includes drilling a microvia opening through a top dielectric layer of a multilayer printed circuit board substrate; desmearing the multilayer printed circuit board substrate including the microvia opening down to a capture pad in a conductive layer; and performing a sequential electrochemical reduction analysis over the capture pad within the microvia opening to determine if a contaminant is found in the microvia opening. If contaminants are found, the method may further include stopping the printed circuit board substrate manufacturing process, taking corrective action to correct the printed circuit board substrate manufacturing process, and restarting the printed circuit board substrate manufacturing process. If contaminants are found, the method may still further include scrapping the multilayer printed circuit board substrate. If no contaminants are found in the microvia opening, the method may further include electrolessly plating the multilayer printed circuit board substrate using a seed layer followed by an electrolytic plating over the elecroless seed layer.

In another embodiment of the invention, a method is provided that includes providing a multilayer printed circuit board substrate having an inner conductive layer sandwiched between a top dielectric layer and a lower dielectric layer, the inner conductive layer including a capture pad for a microvia; drilling a microvia opening through the top dielectric layer over the capture pad; desmearing the multilayer printed circuit board substrate including the microvia opening down to the capture pad; performing a sequential electrochemical reduction analysis within the microvia opening; and determining if the printed circuit board substrate manufacturing process may continue to complete the manufacture of the microvia in response to the sequential electrochemical reduction analysis. If it is determined that the printed circuit board substrate manufacturing process may not continue and the method may further include stopping the printed circuit board substrate manufacturing process, taking corrective action to correct the printed circuit board substrate manufacturing process, and restarting the printed circuit board substrate manufacturing process. If contaminants are found, the method may further include scrapping the multilayer printed circuit board substrate.

In yet another embodiment of the invention, a system is provided including a multilayer printed circuit board substrate and sequential electrochemical reduction analysis (SERA) equipment. The multilayer printed circuit board substrate has a microvia opening in a dielectric layer over a capture pad in a conductive layer. The SERA equipment is used to asses contamination within the microvia opening on the capture pad and includes a vessel, an o-ring seal, a reduction solution within the vessel, a reference electrode, a working electrode, and an analyzer. The vessel has an opening to couple to the multilayer printed circuit board substrate surrounding the microvia opening. The o-ring seal couples between an edge of the opening and the multilayer printed circuit board substrate to provide a liquid seal. The reduction solution within the vessel is over the multilayer printed circuit board substrate in contact with the capture pad in the microvia opening. The reference electrode has one end that extends into the reduction solution. The working electrode has one end that extends into the reduction solution. The analyzer electrically couples to the capture pad, the reference electrode and the working electrode. The analyzer generates a flow of test current in a circuit from the analyzer through the working electrode, the reduction solution, the capture pad, and back to the analyzer. The analyzer measures and records the electrode potential between the capture pad and the reference electrode over a time that the test current flows. The test current causes a sequential electrochemical reduction of contaminants on the capture pad. The contaminants are in the form of oxidized Copper including one or more of cupric-oxide, di-cupric-oxide, and cuprous-sulfide. The reduction solution may be a potassium-chloride (KCl) solution, a sodium-chloride (NaCl) solution, or other type of reduction solution.

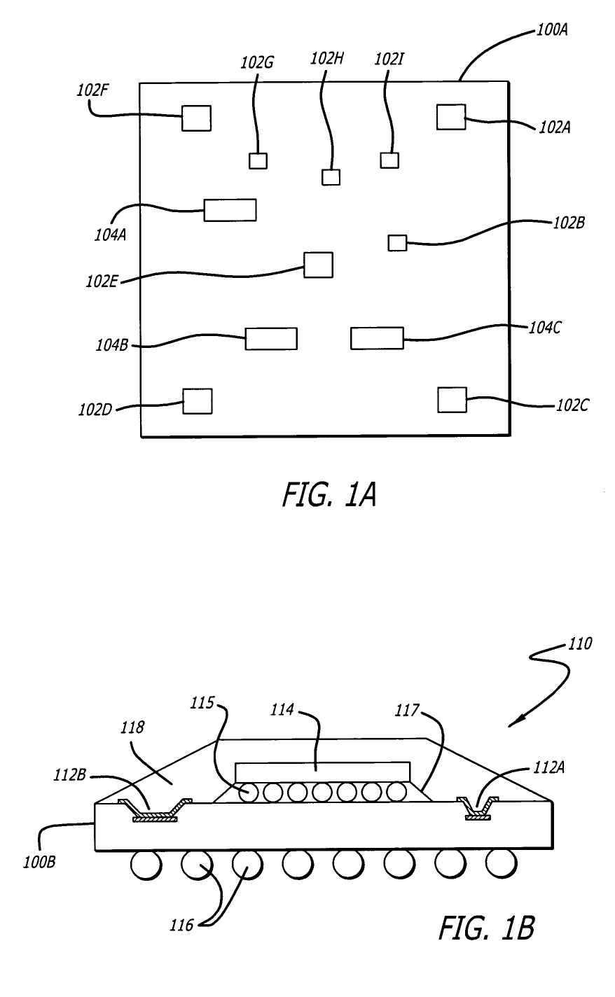

Referring now to FIG. 1A, a top view of a multi-layered printed circuit board (PCB) 100A is illustrated. The printed circuit board 100A includes microvias 102A-102I (generally referred to as microvias 102) and circuit components 104A-104C. The circuit components 104A-104C may be integrated circuits, resistors, capacitors, inductors, transformers, or other passive/active electric circuit components. Of the microvias 102A-102I, a majority of them may be formed at a minimal dimension to make actual metal interconnections, such as microvias 102A, 102B, 102D, and 102G-102I. These microvias may be referred to as interconnect microvias.

One or more microvias may be dimensionally larger than the interconnect microvias to permit them to be used as a test monitor, such as microvias 102C, 102E, and 102F illustrated in FIG. 1A. These microvias may be referred to as test microvias. The test microvias may be positioned in different locations on the printed circuit board 100A to determine microvia reliability at different positions. For example, microvia 102E is located at a center of the printed circuit board 100A, while microvias 102F and 102C are located at corners of the printed circuit board 100A. By using test microvias with larger dimensions, the interconnect microvias with the minimal dimension may be further reduced in size as technology allows. That is, larger sized microvias (i.e., the test microvias) may continue to be used for SERA testing purposes while the interconnect microvias are reduced in size. Additionally, a typical printed circuit board may include a multiplicity of microvias. A small number of test microvias may be used as a statistical sample and tested to characterize the reliability of all the microvias in the entire printed circuit board.

Referring now to FIG. 1B, a packaged integrated circuit 110 is illustrated. Packaged integrated circuit 110 includes a multi-layer printed circuit board 100B, with an interconnect microvia 112A and a test microvia 112B (generally referred to as microvias 102). The test microvia 112B may be larger than the interconnect microvia 112A. The packaged integrated circuit 110 may further include the integrated circuit die 114, solder bumps 115 coupled between integrated circuit 114 and the printed circuit board 100B, and solder balls 116 for coupling to a larger printed circuit board, such as printed circuit board 100A. The packaged integrated circuit 110 may be one of the components 104A-104C discussed previously with reference to FIG. 1A. The packaged integrated circuit 110 may further include an underfill material 117 (e.g., epoxy) between the integrated circuit 114 and the printed circuit board 100B and an encapsulent 118 covering over the integrated circuit 114 and the printed circuit board 100B to encapsulate and protect them from physical damage.

The PCB 100B may also be referred to as a substrate or a printed circuit board substrate. In any case, the PCB 100B has a top surface and a bottom surface opposite the top surface. In addition to the microvias to interconnect conductive layers, the substrate 100B may contain routing traces, power/ground planes, etc., on one or more layers.

The integrated circuit 114 may be attached to the top surface of the substrate 100B by the plurality of solder bumps 115. The solder bumps 115 may be arranged in a two-dimensional array across the integrated circuit 114 and the substrate 100B with a process commonly referred to as controlled collapse chip connection (C4). The solder bumps 115 being conductive can carry electrical current between the integrated circuit 114 and the substrate 100B.

The plurality of solder balls 116 are attached to the bottom surface of the substrate 100B. The solder balls 116 can be reflowed to attach the package 110 to another printed circuit board, such as printed circuit board 100A for example. In addition to the microvias to interconnect conductive layers, the substrate 100B may contain routing traces, power/ground planes, etc., which electrically connect the solder bumps 115 on the top surface of the substrate to the solder balls 116 on the bottom surface of the substrate 100B. With the solder bumps 115 electrically connected to the integrated circuit 114, the integrated circuit 114 may be electrically connected to the solder balls 116 on the bottom surface of the substrate 100B through the routing traces, power/ground planes, microvias of the multiple layers of the PCB substrate 100B.

The microvias 102 in the printed circuit boards 100A and 100B have been analyzed in accordance with the embodiments of the invention so that they are reliably formed.

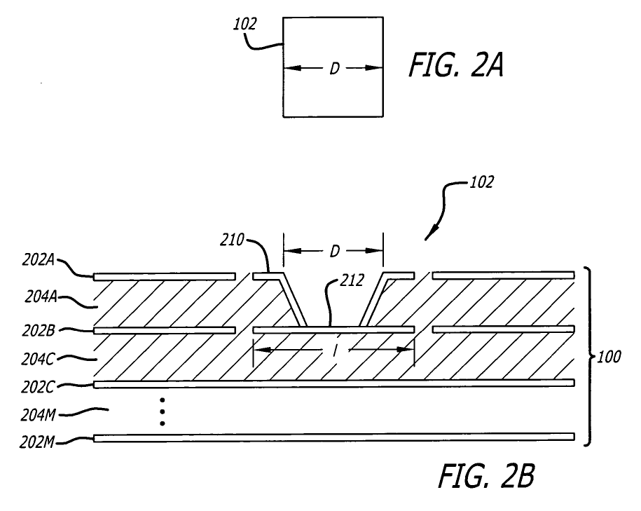

Referring now to FIG. 2A, a magnified top view of a microvia 102 is illustrated. The microvia 102 may be drawn to be square shaped in two dimensions or elongated to be rectangularly shaped in two dimensions when viewed from the top. When manufactured, the microvia may appear more circular-shaped in two dimensions or oval shaped having rounded corners in two dimensions when viewed from the top.

The microvia 102 has a dimension D which may be on the order of 200 to 300 microns. As technology improves, the dimension D may become smaller. To form a test microvia, a larger diameter microvia may be used so that current SERA equipment may continue to be used with the smaller interconnect microvias. For example, a test microvia may have a dimension of 250 microns while an interconnect microvia may have dimensions as small as 50 microns. But for differences in dimension, the test microvia and the interconnect microvia are structurally similar.

Referring now to FIG. 2B, a cross section of the printed circuit board 100 including the microvia 102 is illustrated. The printed circuit board 100 includes a plurality of interconnect layers 202A-202N. To form a microvia, at least two interconnect layers are utilized. Between the interconnect layers 202A-202N may be dielectric layers 204A-204N. The interconnect layers 202A-202N may be formed of conductive material such as metal or other conductor. Typically, the conductive material is copper that is used to form the interconnect layers. Typical dielectric layers 204A-204M may be an ABF (Ajinomoto Buildup Film) dielectric material (e.g., ABF-SH; ABF-GX3 and ABF-GX13) manufactured by Ajinomoto of Japan or any other dielectric material.

The structure of the microvia has a capture pad 212 and an outer layer contact layer 210. While the dimensions of the microvia may be the diameter D, the dimensions of the capture pad 212 are a diameter L which may be larger than the diameter D. Capture pad 212 is formed out of the same material as the conductive layer 202B. Prior to plying the conductor layer 202A that forms that contact layer 210 of the microvia 102, the surface of the capture pad 212 is analyzed using SERA in accordance with the embodiments of the invention.

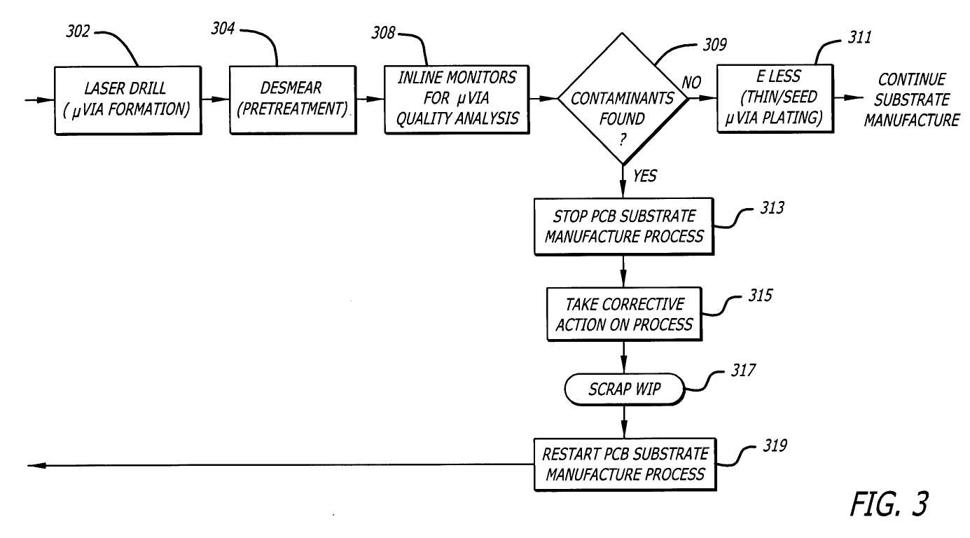

Referring now to FIG. 3, a process flow diagram to form microvias 102 in accordance with an embodiment of the invention is illustrated. At block 302, the microvia formation is begun by drilling an opening into a multilayer printed circuit board substrate down to a conductive layer which forms a capture pad. The drilling of the opening may be performed by a laser or, alternatively, using reactive ion etching.

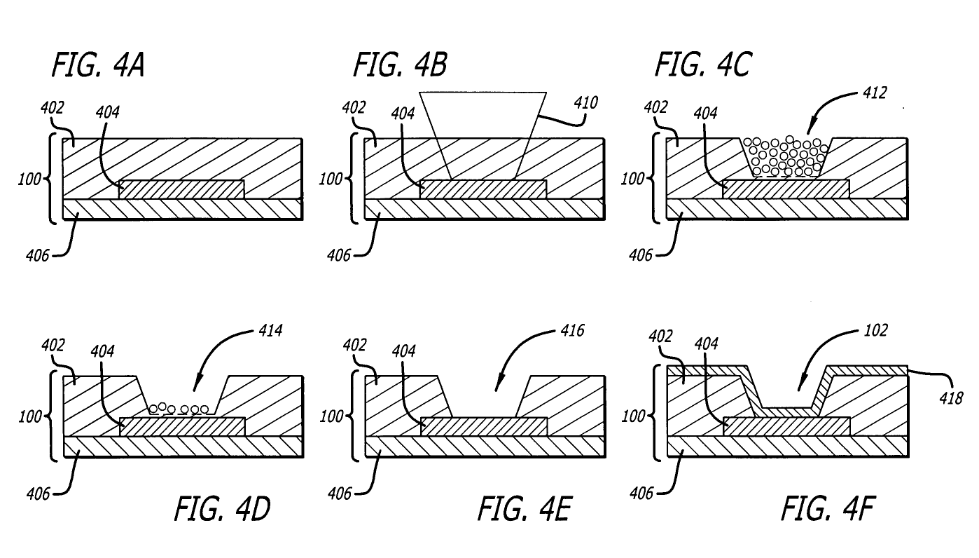

FIG. 4A-4B illustrates the process of laser drilling. A laminated dielectric (ABF) layer 402 on a copper capture pad 404 is drilled using a laser beam 410. The copper capture pad 404 is supported by the underlying ABF layer 406.

At block 304, after laser drilling smear and resin residues are left on the metal contacts that should be removed prior to subsequent metal plating. This is done by a pretreatment process called Desmear. Desmear is simply a process to remove epoxy-resin (including smear) and glass fibers from the microvia opening in an effort to expose a larger copper surface and enhance the later interconnection made by plating. Desmearing of a PCB substrate may be performed by specialized desmear equipment, such as dry plasma etching equipment or chemical etching. The result of the desmear process is illustrated by FIGS. 4C-4E.

In FIG. 4C after the laser drilling process, a resin residue/ABF residue 412 is left. Once a microvia opening is formed by the laser drilling process, cleaning of the microvia bottom surface, including the capture pad, becomes important before the seed layer of Eless copper is plated. If there is any contamination of the microvia bottom that is not removed before Eless Plating, it can result in a weak interface causing microvia failures. It is also important that the level of oxidation of copper be contained to minimal levels in the microvia.

In FIG. 4D, a significant portion of the resin/ABF residue 412 is preliminary cleaned up and reduced down to surface contaminants 414 insitu during the laser drilling process.

In FIG. 4E as a result of the desmearing process, the microvia opening 416 is substantially cleaned down to the capture pad 404.

At block 308, the inline monitors are used to perform a microvia quality analysis. After the desmear process of block 304, a microvia surface/contamination analysis is preformed in accordance with embodiments of the invention. Generally, the microvia surface/contamination analysis at block 308 is performed using sequential electrochemical reduction analysis (SERA). Depending upon how much time the microvias of the printed circuit board substrate are left exposed, the via bottom surface may get oxidized as illustrated in FIG. 4D. If this is the case, the microvia surface/contamination analysis performed at block 308 may detect the surface contaminants to determine if the formation of PCB substrate and the microvias therein should continue or not.

Next at decision block 309, a determination is made as to whether or not the microvia reliability analysis performed at block 308 detects surface contaminants. If no contaminants are found at the decision block 309, the process flow moves to block 311 where the outer contact layer is plated by means of electroless (Eless) plating. Eless plating involves using a seed layer of plating to allow a subsequent electrolytic plating process.

FIG. 4F illustrates that the contact layer 418 has been formed to couple the outer layer to the inner layer of the capture pad 404. After the formation of the microvia 102 is completed in the multi-layer printed circuit board substrate, other manufacturing processes may occur to the multi-layer printed circuit board substrate.

If it is determined at block 309 that contaminants are found, the process flow goes to block 313 where the PCB substrate manufacturing process is stopped. Then at block 315, corrective action is taken on the process to avoid the contamination. At block 317, the lots of the PCB substrates that are works-in-progress (WIP) with the contaminants may be scrapped. After taking the corrective action at block 315 to correct the manufacturing process, the PCB substrate manufacturing process may be restarted. Some lots of PCB substrates may be WIPs at different stages of the manufacturing process and may start at earlier points in the line than other lots of PCB substrates.

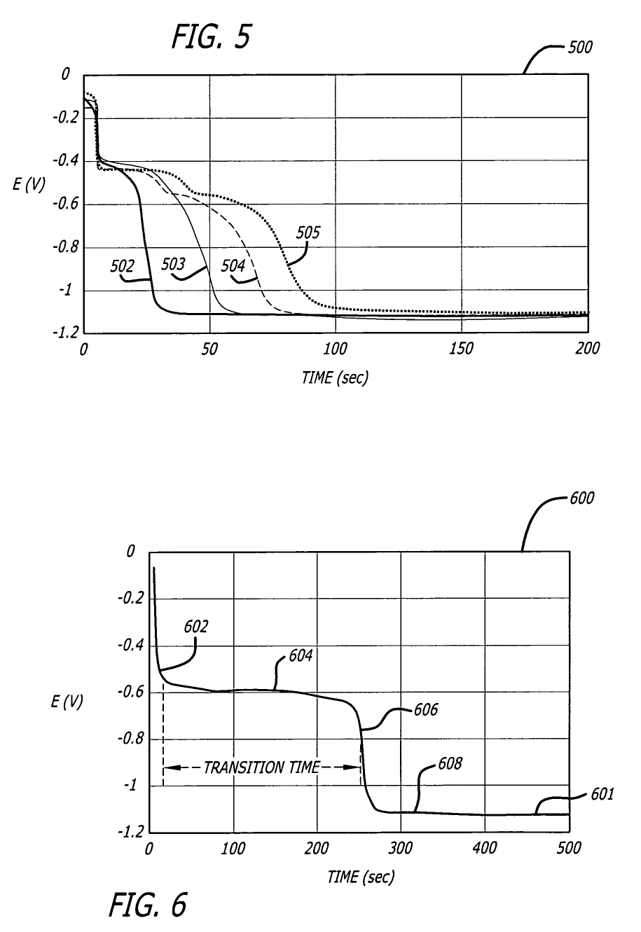

Referring now to FIG. 5, curves 502, 504, 506 and 508 are illustrated on the chart 500. Curves 502-505 illustrate different periods of time that a printed circuit board may be waiting in line within the manufacturing process after the desmearing of block 304 as illustrated in FIG. 3. Curve 502 illustrates a SERA analysis in the formation of copper oxidation after two hours. Curve 503 represents a SERA analysis of copper oxidation after twenty-four hours. Curve 504 illustrates a SERA analysis for copper oxidation after a period of forty-eight hours. Curve 505 illustrates a SERA analysis for copper oxidation after a period of sixty hours. Curves 502-505 illustrate that the longer period of time that a printed circuit board is left waiting after the desmearing process of block 304 (i.e., post desmearing), the greater will be the amount of copper oxidation and surface contaminants on the capture pad. That is, the greater amount of time waiting with incomplete microvias with open capture pads, the reliability of the completed microvia 102 is reduced. If possible, it is preferable to rapidly complete the formation of the microvia after the desmearing process.

Referring now to FIG. 6, a chart 600 illustrates a typical SERA analysis by a curve 601. As time increases on the X axis, the electric potential or voltage, is measured. As the absolute value of the voltage increases, it indicates an increase in resistance over a given period of time. This is because a thickness of a metal conductor is being reduced by the consumption of metal. The reduction in the cross section of the metal causes the increase in resistance. However, if the absolute value of the voltage remains somewhat constant over a given period of time, such as illustrated by plateaus in the curve 600, this indicates that a reduction of a contaminant may be occurring as the resistance of the metal is not increasing.

At point 602 on the curve 601, the start of a reaction with a reactive agent begins. During the plateau at points 604 along the curve 601 a reduction process occurs in a contaminant over a transition time. At points 606, along the curve 601 with increasing magnitude of voltage, the end of the reaction process is reached and additional metal is consumed. At the last plateau at point 608 along curve 601, hydrogen evolution occurs because there is no further metal to consume.

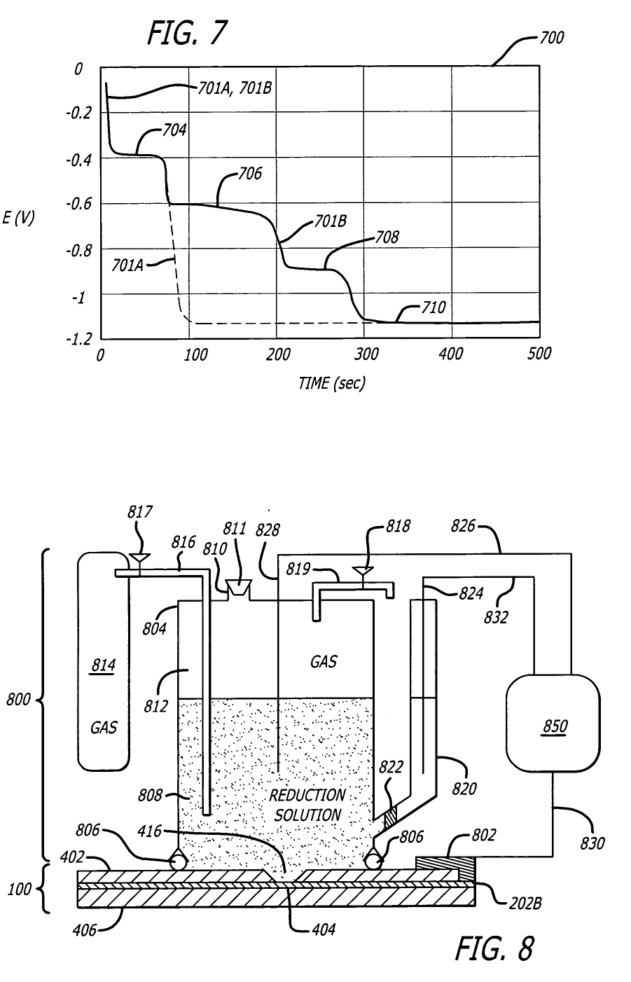

Referring now to FIG. 7, a chart 700 illustrates curves 701A and 701B. Curves 701A and 701B initially follow along the same path as the voltage measurement taken using a SERA analysis. Initially each curve experiences a reduction of cuprous oxide along the plateau at 704. Each then further expands as resistivity increases until approximately 0.6 volts in magnitude where the curves split.

Curve 701A of a SERA analysis indicates a reliable microvia without close contaminants of cupric oxide and cuprous sulfide. Curve 701B represents a failed microvia that would not be reliable as it includes gross contaminants of cupric oxide and cuprous sulfide.

From the split of curves, curve 701A continues to increase in resistance without experiencing any plateaus until it reaches a hydrogen evolution plateau at approximately 100 seconds. From then it experiences a hydrogen evolution along the plateau 710.

Curve 701B at the split experiences a plateau indicating a gross contaminant of cupric oxide at plateau 706. Curve 701B then further experiences an increase in resistivity to 0.8 volts in magnitude until reaching a plateau of approximately 0.9 volts of magnitude where a gross contaminate of cuprous sulfide 708 is reduced. Curve 701B then further expands as an increase in resistivity to about 300 seconds where hydrogen evolution then occurs along the plateau 710 and curves 701A and 701B merge once again. From the chart 700, it is easy to detect whether a microvia may be formed reliably or not based on the differences in the curves 701A and 701B.

Referring now to FIG. 8, an exemplary system for assessing the reliability of microvias 102 is illustrated. The system includes a piece of SERA equipment 800, such as a Model QC-100 SURFACESCAN quality control equipment manufactured by ECI Technology, to analyze the PCB substrate 100. The SERA equipment 800 is a relatively inexpensive piece of equipment that is used very effectively as an inline metrology for microvia reliability.

The PCB substrate 100 is analyzed post desmear and prior to Eless plating at block 308 illustrated in FIG. 3 with the microvia being a work in progress as illustrated by FIG. 4E. The reference numbers on the PCB substrate illustrated in FIG. 8 correspond to the reference numbers used in FIG. 4E. The PCB substrate 100 illustrated in FIG. 8 has the microvia opening 416 leading to the to the capture pad 404 in the conductive layer 202B. Recall that this microvia may be a test microvia that leads to a contact 802 of the PCB substrate 100 to which the SERA equipment 800 may connect.

The SERA equipment 800 may include an open-bottom vessel 804 that has an O-ring 806 around its bottom rim that can seal up against the PCB substrate 100. The vessel 804 may further include a connected chamber 820 with a porous glass frit 822 to partially isolate the reference electrode 824. The vessel 804 is placed atop the PCB substrate 100 around the microvia opening 416 so that the O-ring 806 may seal around it. The vessel 804 may be securely fastened to PCB substrate 100 so that a tight seal is maintained by O-ring 806 around microvia opening 416 during the SERA analysis. With a liquid tight seal, a reduction solution 808 may be added into the vessel 804 through the opening 810.

The reduction solution 808 may be an electrolyte that is compatible with the a soldering system, such as a borate buffer solution (9.55 g/L sodium borate and 6.18 g/L boric acid at a pH of 8.4, for example) suitable for use with the Cu—Sn—Pb system. A wide variety of other electrolytes (e.g., borates, citrates, sulfates, nitrates, etc.) may also provide acceptable results. However, electrolytes having a neutral or alkaline pH, and from which strong metal complexing agents (e.g., chloride, bromide, etc.) have been excluded, may yield the most accurate measurements. In another embodiment of the invention, the reduction solution 808 is potassium chloride (KCl). In yet another embodiment of the invention, the reduction solution 808 is sodium chloride (NaCl).

Next, the opening 810 is sealed and an inert gas 812 is supplied to vessel 804. The inert gas 812 may be supplied from a gas source 814 through the tube 816. Valves 817-818 are opened so that the inert gas 812 from the gas source 814 can flush out the air in the vessel 804 and allow it to vent through tube 819. The inert gas 812 is used to flush air from the vessel 804 to eliminate erroneous electrochemical reduction data that may be caused by the presence of oxygen. The gas source 814 may include a pump (no shown) to pressurize the gas so that it has a greater pressure than atmospheric to properly vent the air from the vessel 804. The inert gas may be argon (Ar) or nitrogen (N₂).

The system 800 may use three electrodes to perform a SERA analysis. The capture pad 404 within the microvia opening 416 acts as a first electrode. The SERA equipment 800 provides an inert counter electrode 829, sometimes referred to as a working electrode, and a reference electrode 824. In some cases, the SERA equipment 800 may have an auxiliary electrode (not shown) to perform additional measurements and perhaps obtain greater accuracy. The reference electrode 824 may be a saturated calomel electrode (SCE) in one embodiment of the invention. The reference electrode 824 extends into the reduction solution 808. The inert counter electrode 828 may be a platinum electrode in one embodiment of the invention. The inert counter electrode 828 extends into the reduction solution 808.

At the heart of the system 800 is a test and measurement analyzer 850. The test and measurement analyzer 850 controls the testing and takes the measurements to provide the results of the SERA analysis. The test and measurement analyzer 850 includes a current source, and a volt meter coupled to the electrodes 824,828 and the microvia capture pad. The test and measurement analyzer 850 further includes a recording device to record the level of current and voltage over time.

The test and measurement analyzer 850 provides a test current for the electrochemical reduction of metallic oxides and other contaminants on the capture pad 404, if any. The test current may be a relatively low level of current density such as on the order of 10-1000 microamps per centimeter squared of test area. A higher level of current density may be used to speed up the SERA analysis at the expense of accuracy. Alternatively, a lower level of current density may be used to obtain better SERA analysis at the expense of time delay. The test current is a negative current that is passed between the microvia capture pad 404 and the working electrode 828 while the potential between the microvia capture pad 404 and the reference electrode 824 is recorded as a function of time. In cases where the working electrode 828 has a stable voltage at low currents, the working electrode 828 may also function as the reference electrode, thereby eliminating the need for the separate reference electrode 824.

The test current from the analyzer 850 travels through the wire conductor 826, the inert counter electrode 828, into the reduction solution 808, to the capture pad 404, to the contact 802, and through wire conductor 830 back to the analyzer 850. The analyzer measures and records changes in the test current over time as the SERA analysis takes place. The analyzer 850 also measures and records the electrode potential between the capture pad 404 and the reference electrode 824 as a function of time during electrochemical reduction of the metallic oxides on the capture pad 404. This is done by the circuit including the analyzer 850, the wire conductor 832, the reference electrode 824, the reduction solution 808, the capture pad 404, through to the contact 802, and the wire conductor 803 back to the analyzer 850. The reference electrode 824 may be used within the chamber 820 or located elsewhere in the vessel 804. Moreover in some cases, the reference electrode 824 may be eliminated as the electrode 828 may provide the function of the reference electrode in some circumstances.

In operation, the analyzer 850 provides a constant test current of a low level. The current causes a sequential electrochemical reduction of the oxides on the bare copper of the capture pad. While supplying the constant test current, the analyzer measures and records the electrode potential between capture pad and the reference electrode as a function of time. The time factor can be used to convert the current density into a charge density by multiplying the current density by the elapsed time. The measure of electrode potential versus charge density (or time) produces a series of inflection points or plateaus that indicate the particular oxides that are being reduced as well as the thicknesses of the various oxide layers. The results can be compared to known baseline data to determine the specific oxides present on a capture pad.

As described previously with reference to FIG. 7, the record of electrode potential versus time can be compared to determine if a microvia capture pad is acceptable or not and if not, what type of oxides or contaminants may be present within the microvia opening 416 and the capture pad 404. In this manner, microvia reliability may be determined in advance so that corrective measures may be taken prior to complete formation of the microvias.

The SERA metrology disclosed herein helps to catch gross contamination in the manufacturing process (i.e., inline) as a work in progress, prior to the end of the line. That is, the embodiments of the invention will detect microvia reliability issues in-line in contrast to detecting unreliable microvias at the end of line when it is too late to make repairs.

Traditional monitors used in PCB manufacturing lines require complete manufacture of the PCB substrate and then cannot even determine the root cause of microvia failure. With the use of SERA metrology, an excursion due to undesired material is detected in real time within the manufacturing process using a work in progress. Any contamination of the base copper surface of the microvia, either due to resin residue and/or oxidized Cu will be detected in real time using the SERA metrology disclosed herein. Bad material will be contained inline, without further manufacturing costs, rather than at the end of the line four to five weeks later.

The use of SERA to determine microvia reliability prior to Eless plating can intercept manufacturing lots of PCB substrates that have potential microvia reliability issues. The manufacturing lots analyzed to be contaminated and generate potential microvia failures are typically scrapped without having to complete the PCB substrate manufacturing process. Catching potential microvia failures early in the manufacturing line avoids the extra costs of completing the manufacture of a PCB substrate that has a high probability of microvia failures at the end of the line.

While certain exemplary embodiments of the invention have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A method comprising:
drilling a microvia opening through a top dielectric layer of a multilayer printed circuit board substrate;
desmearing the multilayer printed circuit board substrate including the microvia opening down to a capture pad in a conductive layer; and
performing a sequential electrochemical reduction analysis over the capture pad within the microvia opening to determine if a contaminant is found in the microvia opening.

2. The method of claim 1, wherein
the determining finds a contaminant in the microvia opening and the method further comprises
stopping the printed circuit board substrate manufacturing process,
taking corrective action to correct the printed circuit board substrate manufacturing process, and
restarting the printed circuit board substrate manufacturing process.

3. The method of claim 1, wherein
the determining finds no contaminant in the microvia opening and the method further comprises
electrolessly plating the multilayer printed circuit board substrate using a seed layer.

4. The method of claim 1, wherein
the contaminant is one of cupric-oxide, di-cupric-oxide, and cuprous-sulfide.

5. The method of claim 1, wherein
the microvia opening is for a test microvia and has a diameter larger than a microvia opening for an interconnect microvia.

6. The method of claim 5, wherein
the capture pad is for the test microvia and has an area larger than an area of a capture pad for the interconnect microvia.

7. The method of claim 1, wherein
the drilling comprises using a laser to form the microvia opening.

8. A method comprising:
providing a multilayer printed circuit board substrate having an inner conductive layer sandwiched between a top dielectric layer and a lower dielectric layer, the inner conductive layer including a capture pad for a microvia;
drilling a microvia opening through the top dielectric layer over the capture pad;
desmearing the multilayer printed circuit board substrate including the microvia opening down to the capture pad;
performing a sequential electrochemical reduction analysis within the microvia opening; and
determining if the printed circuit board substrate manufacturing process may continue to complete the manufacture of the microvia in response to the sequential electrochemical reduction analysis.

9. The method of claim 8, wherein
the determining determines if a contaminant is found on the capture pad in the microvia opening.

10. The method of claim 9, wherein
the contaminant is one of cupric-oxide, di-cupric-oxide, and cuprous-sulfide.

11. The method of claim 8, wherein
it is determined that the printed circuit board substrate manufacturing process may continue to complete the manufacture of the microvia and the method further comprises
plating into the microvia opening using an electroless seed layer followed by electrolytic plating over the electroless seed layer.

12. The method of claim 8, wherein
it is determined that the printed circuit board substrate manufacturing process may not continue and the method further comprises
stopping the printed circuit board substrate manufacturing process,
taking corrective action to correct the printed circuit board substrate manufacturing process, and
restarting the printed circuit board substrate manufacturing process.

13. The method of claim 12, further comprising:
scrapping the multilayer printed circuit board substrate.

14. The method of claim 8, wherein
the drilling comprises using a laser to form the microvia opening.

15. The method of claim 8, further comprising:
mounting an integrated circuit with solder bumps to a top surface of the multilayer printed circuit board substrate; and
coupling solder balls to a bottom surface of the multilayer printed circuit board substrate.

16. The method of claim 15, further comprising:
underfilling the integrated circuit with an underfill material between the integrated circuit and the top surface of the multilayer printed circuit board substrate.

17. The method of claim 16, further comprising:
encapsulating the integrated circuit and the multilayer printed circuit board substrate using an encapsulant on top of the integrated circuit and the top surface of the multilayer printed circuit board substrate.

18. The method of claim 8, wherein
the microvia is a test microvia with the microvia opening and the capture pad having larger dimensions than those of an interconnect microvia.

19. A system comprising:
a multilayer printed circuit board substrate having a microvia opening in a dielectric layer over a capture pad in a conductive layer; and
sequential electrochemical reduction analysis (SERA) equipment to asses contamination within the microvia opening on the capture pad, the SERA equipment having
a vessel with an opening coupled to the multilayer printed circuit board substrate surrounding the microvia opening,
an o-ring seal coupled between an edge of the opening and the multilayer printed circuit board substrate to provide a liquid seal,
a reduction solution within the vessel over the multilayer printed circuit board substrate in contact with the capture pad,
a reference electrode with one end extending into the reduction solution,
a working electrode with one end extending into the reduction solution, and
an analyzer electrically coupled to the capture pad, the reference electrode and the working electrode, the analyzer to generate a flow of test current in a circuit from the analyzer through the working electrode, the reduction solution, the capture pad, and back to the analyzer, the analyzer to further measure and record the electrode potential between the capture pad and the reference electrode over a time that the test current flows.

20. The system of claim 19, wherein
the test current causes a sequential electrochemical reduction of contaminants on the capture pad.

21. The system of claim 20, wherein
the contaminants are in the form of oxidized Copper including one or more of cupric-oxide, di-cupric-oxide, and cuprous-sulfide.

22. The system of claim 19, wherein
the analyzer includes a current source to generate the test current and a volt meter to measure the electrode potential between the capture pad and the reference electrode.

23. The system of claim 19, wherein
the reduction solution is a potassium-chloride (KCl) solution.

24. The system of claim 19, wherein
the reduction solution is a sodium-chloride (NaCl) solution.
